(19) United States
(12) Patent Application Publication
(10) Pub. No.: US 2009/0262300 A1
(43) Pub. Date: Oct. 22, 2009

(54) Eye glasses securing device

(75) Inventor: Murray H. McElhone, LauderHill, FL (US)

Correspondence Address: JAMES RAY & ASSOCIATES, 2640 PITCAIRN ROAD, MONROEVILLE, PA, 15146, US

(73) Assignee: EFFECTIVE CONNECTIONS, Inc.

(21) Appl. No.: 12/148,691

(22) Filed: Apr. 22, 2008

(51) Int. Cl. G02C 3/02; G02C 11/02

(52) U.S. Cl. 351/156; 351/52

(57) ABSTRACT

An eye glasses securing device for securing a pair of eye glasses to a user's head is provided. Such device includes a flexible elongated member having a first predetermined diameter and a first predetermined length. A first member is secured to a first end of such flexible elongated member, such first member being engageable with a first side of a frame portion of a pair of eye glasses. A second member is secured to a second end of such flexible elongated member, the second member being engageable with a second side of such frame portion of such pair of eye glasses. A mechanism is operably connected to such first member at a predetermined location thereon for retaining such first member's engagement with such frame portion. A second mechanism is operably connected to the second member at a predetermined location thereon for retaining the second member's engagement with such frame portion.

### FIELD OF THE INVENTION

The present invention relates, in general, to eye glasses and, more particularly, this invention relates to securing devices for eye glasses.

### BACKGROUND OF THE INVENTION

Prior to the conception and development of the present invention, eye glasses or glasses, as are generally well known in the prior art, are worn for a variety of reasons including correcting a person's vision, as an accessory, as sun glasses, as safety glasses, and the like. Typically, such glasses have two arms for extending past a person's temples and resting on such person's ears. Often the arms of the glasses break or are uncomfortable. Furthermore, the arms may be a loose fit or loosen over time resulting in the glasses falling off a user's face when such user is participating in sports, recreational activities, working, bending over, exercising, playing, etc. The result can be breakage of the glasses or scratching of the glasses lenses, inconvenience and frustration for such user, and the glasses may even become lost. Therefore, there exists a need for a comfortable device which can hold such glasses on a user's head such that the glasses are comfortably secured to such user's face.

### SUMMARY OF THE INVENTION

The present invention provides an eye glasses securing device for securing a pair of eye glasses to a user's head. Such device includes a flexible elongated member manufactured from a first predetermined material and having a first predetermined diameter and a first predetermined length. A first member is secured to a first end of the flexible elongated member, such first member being engageable with a first side of a frame portion of a pair of eye glasses. A second member is secured to a second end of the flexible elongated member, the second member being engageable with a second side of such frame portion of such pair of eye glasses. A first means is operably connected to the first member at a predetermined location thereon for retaining the first member's engagement with such frame portion. A second means is operably connected to the second member at a predetermined location thereon for retaining the second member's engagement with such frame portion.

### OBJECTS OF THE INVENTION

It is, therefore, one of the primary objects of the present invention to provide a device for securing glasses to at least one of a user's face, head and body.

Another object of the present invention is to provide a securing device for securing glasses to a user's face, such device being tension adjustable such that the glasses will remain comfortably and securely in place during various activities and conditions such as sports and inclement weather conditions.

Still another object of the present invention is to provide a device for attachment to a user's eye glasses, such as reading glasses, sunglasses, and the like, which includes a cord for use securing the glasses to a user's face and head and for hanging such glasses around a user's neck when the glasses are not in use.

Yet another object of the present invention is to provide a means for alleviating a user's fear of losing his or her glasses while participating in activities which require a lot of motion.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of prior art.

FIG. 2 is a partial perspective view of the invention according to one embodiment of the invention.

FIG. 3 is a partial perspective view of the invention according to one embodiment of the invention.

FIG. 4 is a partial perspective view of the invention according to one embodiment of the invention.

FIG. 5 is a partial perspective view of the invention according to one embodiment of the invention.

FIG. 6 is a partial perspective view of the invention according to one embodiment of the invention.

FIG. 7 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

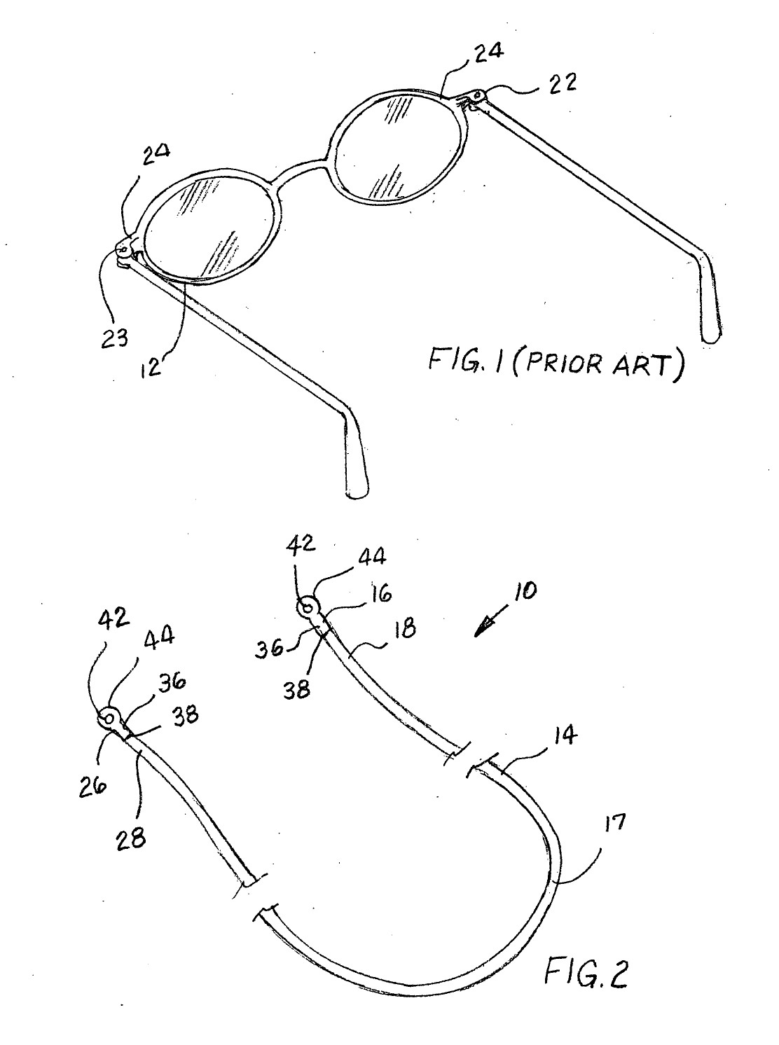

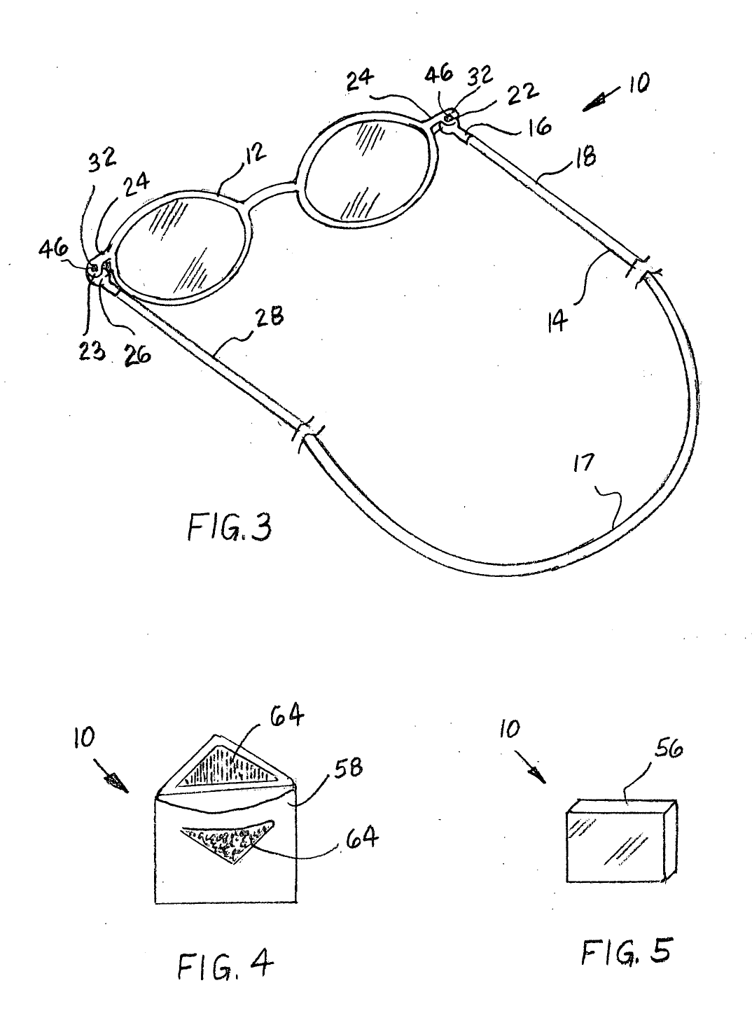

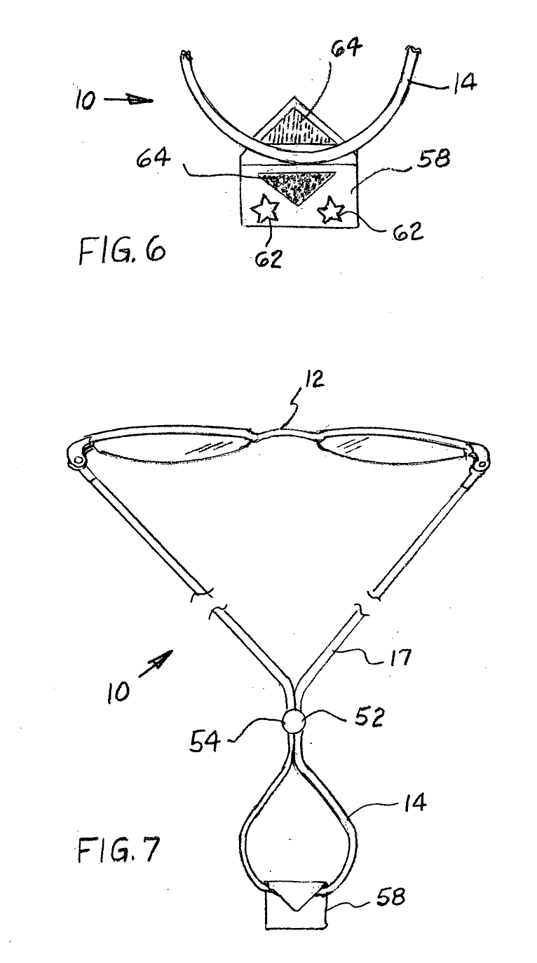

Reference is now made, more particularly, to FIGS. 1-7.

An eye glasses securing device, generally designated 10, for securing a pair of eye glasses 12 to a user's head (not shown) is provided.

It is presently preferred that the arms of the pair of eye glasses be removed prior to use of the eye glasses securing device 10.

Such eye glasses securing device 10 includes a flexible elongated member 14 is manufactured from a first predetermined material and has a first predetermined diameter and a first predetermined length.

A first member 16 is secured to a first end 18 of said flexible elongated member 14. Such first member 16 is engageable with a first side 22 of a frame portion 24 of a pair of eye glasses 12.

A second member 26 is secured to a second end 28 of such flexible elongated member 14. Such second member 26 is engageable with a second side 23 of such frame portion 24 of such pair of eye glasses 12.

A first means 32 is operably connected to the first member 16 at a predetermined location thereon for retaining the first member's engagement with such frame portion 24.

A second means 32 is operably connected to the second member 26 at a predetermined location thereon for retaining the second member's 26 engagement with such frame portion 24.

It is presently preferred that such flexible elongated member 14 is at least one of a cord, a rope, a lace, a chain, and elastic. It is presently most preferred that such flexible elongated member is a cord 17.

It is presently preferred that such predetermined diameter is between about 5/30 inches in diameter and 5/34 inches in diameter.

It is presently preferred that such predetermined length is between about 28.00 inches and 32.00 inches.

It is presently preferred that such first member 16 and such second member 26 each include a respective sleeve portion 36 for being operably connected to such cord 17 at a first end 38 thereof, and wherein said first member 16 and said second member 26 each include a respective apertured portion 42 at a second end 44 thereof for being operably connected to such respective frame portions 24 at predetermined locations thereon. The sleeve portions 36 and the apertured portions 42 being manufactured from a second predetermined material and having a second predetermined size and a second predetermined shape.

It is presently preferred that such second predetermined material is at least one of metal and plastic. It is presently most preferred that such second predetermined material is metal.

It is presently preferred that such first and second means 32 includes at least one of clamps, screws, and adhesive type fastening means. It is presently most preferred that such first and second means 32 includes screws 46 for screwing into predetermined portions of such frame portions 24 and the apertured portions 42.

It is presently preferred that such glasses securing device 10 further includes a tension adjusting means 52 operably connected to the cord 17 at a predetermined location thereon for slidably tightening and loosening the cord 17 such that the cord 17 may be secured tightly around such user's head when such glasses securing device 10 is secured to such frame portions 24 and such user is wearing such glasses 12.

It is presently preferred that such tension adjusting means 52 is a toggle type adjusting means 54 operably connected to such cord 17 at a predetermined location thereon.

It is presently preferred that such eye glasses securing device 10 further includes at least one weight member 56 operably connectable to the flexible elongated member 14 at a predetermined location thereon for further supporting such glasses securing device 10 in securing such glasses 12 to such user's head, the at least one weight member 56 being manufactured from a predetermined material and having a predetermined size, a predetermined shape and a predetermined weight. It is presently preferred that such predetermined weight is between about 0.25 ounces and 2.0 ounces.

It is presently preferred that such eye glasses securing device 10 further includes a generally hollow housing member 58 manufactured from a predetermined material and having a predetermined size and a predetermined shape. It is presently preferred that such predetermined material is vinyl.

Such housing member 58 is releasably connected to the flexible elongated member 14 at a predetermined location thereon for housing at least one weight member 56. The at least one weight member 56 has a predetermined size, a predetermined shape and a predetermined weight and is for supporting such glasses securing device 10 in retaining such eye glasses 12 in a predetermined position on such user's head.

It is presently preferred that such housing member 58 includes predetermined indicia 62 thereon. It is presently preferred that such predetermined indicia 62 includes at least one of information relating to a user, information relating to such predetermined object, warnings, directions, symbols, numbers, letters, pictorial designs, sports teams, school affiliations, business affiliations, political affiliation, religious affiliations, hobbies, photographic images, and a combination thereof.

It is presently preferred that such housing further includes a securing means 64 for releasably securing such housing member 58 to the flexible elongated member 14.

It if further presently preferred that such securing means 64 is at least one of snaps, buttons, and a hook and loop type securing means.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An eye glasses securing device for securing a pair of eye glasses to a user's head comprising;
a. a flexible elongated member manufactured from a first predetermined material and having a first predetermined diameter and a first predetermined length;
b. a first member secured to a first end of said flexible elongated member, said first member being engageable with a first side of a frame portion of such pair of eye glasses;
c. a second member secured to a second end of said flexible elongated member, said second member being engageable with a second side of such frame portion of such pair of eye glasses;
d. a first means operably connected to said first member at a predetermined location thereon for retaining said first member's engagement with such frame portion; and
e. a second means operably connected to said second member at a predetermined location thereon for retaining said second member's engagement with such frame portion.

2. An eye glasses securing device according to claim 1 wherein said flexible elongated member is at least one of a cord, a rope, a lace, a chain, and elastic.

3. An eye glasses securing device according to claim 1 wherein said flexible elongated member is a cord.

4. An eye glasses securing device according to claim 3 wherein said first member and said second member each include a respective sleeve portion for being operably connected to said cord at a first end thereof, and wherein said first member and said second member each include a respective apertured portion at a second end thereof for being operably connected to such respective frame portions at predetermined locations thereon, said sleeve portions and said apertured portions being manufactured from a second predetermined material and having a second predetermined size and a second predetermined shape.

5. An eye glasses securing device according to claim 4 wherein said first and second means includes at least one of clamps, screws, and adhesive type fastening means.

6. An eye glasses securing device according to claim 4 wherein said first and second means includes screws for screwing into predetermined portions of such frame portions and said apertured portions.

7. An eye glasses securing device according to claim 1 wherein said predetermined length is between about 28.00 inches and 32.00 inches.

8. An eye glasses securing device according to claim 4 wherein said second predetermined material is at least one of metal and plastic.

9. An eye glasses securing device according to claim 8 wherein said second predetermined material is metal.

10. An eye glasses securing device according to claim 3 wherein said glasses securing device further includes a tension adjusting means operably connected to said cord at a predetermined location thereon for slidably tightening and loosening said cord such that said cord may be secured tightly around such user's head when said glasses securing device is secured to such frame portions and such user is wearing such glasses.

11. An eye glasses securing device according to claim 10 wherein said tension adjusting means is a toggle type adjusting means.

12. An eye glasses securing device according to claim 1 wherein said eye glasses securing device further includes at least one weight member operably connectable to said flexible elongated member at a predetermined location thereon for further supporting such glasses securing device in securing such glasses to such user's head, said at least one weight member being manufactured from a predetermined material and having a predetermined size, a predetermined shape and a predetermined weight.

13. An eye glasses securing device according to claim 12 wherein said eye glasses securing device further includes a generally hollow housing member manufactured from a predetermined material and having a predetermined size and a predetermined shape, said housing member being releasably connected to said flexible elongated member at a predetermined location thereon for housing said at least one weight member.

14. An eye glasses securing device according to claim 13 wherein said housing member includes predetermined indicia thereon.

15. An eye glasses securing device according to claim 14 wherein said predetermined indicia includes at least one of information relating to a user, information relating to such predetermined object, warnings, directions, symbols, numbers, letters, pictorial designs, sports teams, school affiliations, business affiliations, political affiliation, religious affiliations, hobbies, photographic images, and a combination thereof.

16. An eyeglasses securing device according to claim 1 wherein said predetermined diameter is between about 5/30 inches in diameter and 5/34 inches in diameter.

17. An eyeglasses securing device according to claim 12 wherein said predetermined weight is between about 0.25 ounces and 2.0 ounces.

18. An eyeglasses securing device according to claim 13 wherein said predetermined material is vinyl.

19. An eyeglasses securing device according to claim 13 wherein said housing further includes a securing means for releasably securing said housing to said flexible elongated member.

20. An eyeglasses securing device according to claim 19 wherein said securing means is at least one of snaps, buttons, and a hook and loop type securing means.
